(19) United States
(12) Patent Application Publication
(10) Pub. No.: US 2008/0220983 A1
(43) Pub. Date: Sep. 11, 2008

(54) Functional arrays for high throughput characterization of regulatory elements in untranslated regions of genes

(75) Inventors: Nathan Trinklein, Redwood City, CA (US); Shelley Force Aldred, Hayward, CA (US)

Correspondence Address: WILSON SONSINI GOODRICH & ROSATI, 650 PAGE MILL ROAD, PALO ALTO, CA, 94304-1050, US

(73) Assignee: SwitchGear Genomics a California Corporation, Menlo Park, CA (US)

(21) Appl. No.: 12/074,856

(22) Filed: Mar. 5, 2008

Related U.S. Application Data
(60) Provisional application No. 60/905,727, filed on Mar. 8, 2007.

(51) Int. Cl. C40B 30/06; C40B 40/06; C40B 40/02; G06Q 30/00; C40B 60/08

(52) U.S. Cl. 506/10; 506/16; 506/14; 506/37; 705/1

(57) ABSTRACT

This invention provides libraries of expression constructs having different untranslated regions (UTR) from a genome. The expression constructs include transcription regulatory sequences operably linked with a reporter gene and a 5′ UTR, a 3′ UTR or both, wherein the translation of the reporter gene is under the regulatory control of control regions in the UTR sequence. The libraries of this invention are useful for determining the impact of regulatory sequences in the UTRs on translation of open reading frames under a variety of conditions, such as different cellular environments.

### CROSS-REFERENCE

This application claims the benefit of U.S. Provisional Application No. 60/905,727, filed Mar. 8, 2007, which application is incorporated herein by reference.

### SEQUENCE LISTING

A CD containing a formal sequence listing was filed in this application and the contents of the CD are expressly incorporated herein in their entirety by reference. SEQ ID NOs: 1-17520 are provided on a compact disc as file name SGG08_UTR_SEQ.txt enclosed with this filing.

### BACKGROUND OF THE INVENTION

In the post-genome era, high-throughput genomics studies have made great leaps forward. The relatively recent ability to study gene regulation on a genome-wide scale, such as with expression microarrays and ChIP-chip, has yielded new insights into genetic pathways and networks. These technologies provide observational data but leave gaps in network and pathway knowledge such as identification of the functional elements that affect the mRNA levels measured on a microarray. For example, if a group of mRNAs show an increase in steady-state levels after induction with a particular compound, a researcher will be left with questions about what caused the change in steady-state levels. The difference may result from changes in transcriptional regulation or mRNA stability, or a combination of both. Untranslated Region (UTR) sequences can play a major role in regulation of protein translation from a mature mRNA, and a change in transcript stability may affect total protein expression. To more completely understand the mechanism of gene regulation, researchers need the ability to interrogate the function of transcriptional and post-transcriptional regulatory elements on a large scale.

Promoter-reporter assays have been a standard approach for studying transcriptional regulatory element function for many years. However, it has only been in the last few years that progress has been made in applying this approach to studying hundreds of promoters in a single experiment (Cooper et al. 2006). On the other hand, though studies of the function of UTR sequences using hybrid reporter-UTR assays have been used for a handful of genes, a gap exists in tools available for studying these elements on a large scale. Indeed, evidence continues to accumulate regarding the importance of UTR function in regulating transcript stability and localization along with playing a role in the regulation of translation (reviewed in Conne et al. 2000).

### SUMMARY OF THE INVENTION

The present invention relates to high-throughput methods for structural and functional characterization of gene expression regulatory elements, specifically those in the untranslated regions of gene transcripts in the human genome. In preferred embodiments, the regulatory element is an untranslated region (UTR) in an mRNA transcript. Each of the UTR regulatory elements can be characterized in terms of its genomic location, sequence, variation, mutation, polymorphism, mRNA stability and localization regulatory activity in different cell or tissue type, and binding affinity with other regulatory factors, such as RNA binding proteins.

In one aspect this invention provides a library of a different expression constructs, each of a plurality of members of the library comprising a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides, at least 50 nucleotides, at least 100 nucleotides or at least 1000 nucleotides operably linked with a reporter sequence that is heterologous to the UTR sequence such that expression of the reporter sequence is under post-transcriptional control of the UTR sequences. In one embodiment the UTR sequence is a 3′ UTR sequence and is positioned 3′ to the reporter sequence. In another embodiment the UTR sequence is a 5′ UTR sequence and is positioned 5′ to the reporter sequence. In another embodiment the transcribable sequence comprises a 3′ UTR sequence positioned 3′ to the reporter sequence and a 5′ UTR sequence positioned 5′ to the reporter sequence. In another embodiment the transcription regulatory sequence is common among the constructs and is heterologous to the UTR sequences. In another embodiment the UTR sequence comprises the entire transcribed UTR sequence of a naturally occuring transcript. In another embodiment a plurality comprising at least 20% of the UTR sequences of said expression constructs in said library are part of a common pathway that can include: UTR sequences that control the expression of genes involved in the same biological process; UTR sequences that are all bound by the same protein, complex of proteins, other nucleic acid binding proteins, other nucleir acid molecules such as microRNAs, or other small molecule; UTR sequences that control the expression of genes whose transcript levels or proteins levels change upon treatment or exposure to the same stimulus; UTR sequences that contain the same sequence motif or collection of sequence motifs wherein a sequence motif is string of 2 or more nucleotides; UTR sequences that control the expression of genes whose sequences, transcripts or proteins are connected via metabolic transformations and/or physical protein-protein, protein-DNA and protein-compound interactions. In another embodiment the UTR sequences are selected from the group consisting of SEQ ID NO: 1-17520. In another embodiment the library comprises at least ten, at least 50, at least 100, at least 200, or at least 1000 expression constructs. In another embodiment the expression construct is a plasmid or viral construct. Each nucleic acid segment comprises at least 20%, at least 40%, at least 60%, or at least 80% of the nucleotides that make up a UTR sequence. In another embodiment the reporter sequence is common among the constructs. In another embodiment the reporter sequence encodes a light-emitting reporter molecule, a fluorescent reporter molecule or a colorimetric molecule. In another embodiment each reporter sequence comprises a pre-determined, unique nucleotide barcode and/or a reporter that reports a visible signal. In another embodiment the genome is a mammalian genome, human genome or a mouse genome.

In another aspect this invention provides a library of isolated nucleic acid molecules, each of a plurality of members of the library comprising a different, pre-determined nucleic acid segment from a genome, wherein the segment comprises UTR sequences, wherein a plurality comprising at least 20% of the UTR sequences in said library are part of a common pathway. In one embodiment the library comprises at least 10 different pre-determined nucleic acid segment from a genome, wherein about 50% of the UTR sequences of said library are part of said common pathway.

In another aspect this invention provides a library of cells, wherein each of a plurality of cells in the library of cells comprises a different expression construct, each construct having a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences. In certain embodiments are human cells or non-human cells.

In another aspect this invention provides a device comprising receptacles, each or a pluraity of receptacles containing a different expression construct, each expression construct having a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences, wherein each member has a known location among the receptacles. In one embodiment the plurality has a diversity of at least 10 different nucleic acid segments. In another embodiment the constructs are in the form of a dried nucleic acid or are in solution. In another embodiment the constructs are in a stabilized transfection matrix. In another embodiment the receptacles are comprised in a microtiter plate such as a 96-well plate, a 384-well plate or a 1536 well plate. In another embodiment at least at least 10 different expression constructs wherein about 50% of the UTR sequences of said expression constructs in said library are part of said common pathway.

In another aspect this invention provides a device comprising a solid substrate comprising a surface and nucleic acid molecules immobilized to the surface, each at a different known location, wherein each molecule comprises a nucleotide sequence of at least 10 nucleotides from a genomic segment comprising UTR sequences. In one embodiment the device comprises UTR sequences from at least 10 different genomic segments. In another embodiment the device comprises at least 10 different UTR sequences from genomic segments wherein about 50% of the UTR sequences in said device are part of a common pathway.

In another aspect this invention provides a method comprising: providing a device comprising receptacles, each of a plurality of the receptacles containing a different member of a library of cells, wherein each of a plurality of the cells in the library comprises a different member of the library of expression constructs, each of a plurality of the expression constructs characterized by having a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences; wherein each member of the library of cells has a known location among the receptacles; culturing the cells; and measuring the level of expression of the reporter sequence in each receptacle. In one embodiment the library has a diversity of at least 10 different nucleic acid segments. In another embodiment the step of providing the device comprises: providing a device comprising at least one plate comprising a plurality of receptacles, each receptacle containing a different member of the library of expression constructs, wherein each member of the library of expression constructs has a known location among the receptacles; delivering cells to each of the receptacles; and transfecting the cells with the expression constructs. In another embodiment the method further comprises: perturbing the cells in each receptacle; measuring the level of expression of the reporter sequence in each receptacle; and determining whether the level of expression in any receptacle changed after perturbing the cells. In another embodiment perturbing comprises contacting the cells in each receptacle with a test compound, exposing the cells to different environmental conditions, or genetically modifying the cells either permanently or transiently such as by inducing mutation, overexpressing a transcript for example by transfecting with a cDNA or decreasing expression of a transcript by siRNA. In another embodiment perturbing comprises contacting the cells in each receptacle with a test compound. In another embodiment the method further comprises identifying a compound that alters UTR activity. In another embodiment said cells in said library of cells comprises cells associated with a condition. In another embodiment each cell in said library of cells comprises a DNA polymorphism such as SNP (single nucleotide polymorphism), STR (simple tandem repeat), VTR (variable tandem repeat) and RFLP (restriction fragment length polymorphism), or DNA mutation.

In another aspect this invention provides a method to determine the functional effect of a DNA polymorphism or DNA mutation in the post-transcriptional activity of a polynucleotide comprising: providing a first library of cells wherein said first library comprises cells comprising said DNA polymorphism or DNA mutation; providing a second library of cells wherein said second library comprises cells not comprising said DNA polymorphism or DNA mutation; providing a device comprising a plurality of receptacles, each receptacle containing a different member of said first library of cells or said second library of cells, wherein each cell in said first and second library of cells comprises a different member of the library of expression constructs, each expression construct characterized by having a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences; wherein a plurality comprising at least 20% of the UTR sequences in said device are part of a common pathway and wherein each member of the library of cells has a known location among the receptacles; culturing the cells; measuring the level of expression of the reporter sequence in each receptacle; and comparing the level of expression of the reporter sequence to each UTR sequence between said first library of cells and said second library of cells thereby determining the effect of said DNA polymorphism or DNA mutation in the post-transcriptional regulation of a polynucleotide. In one embodiment said DNA polymorphism is selected for the group consisting of SNP, STR, VTR, RFLP, deletions, and insertions.

In another aspect this invention provides a business method comprising commercializing the compositions, devices of methods of any of the foregoing inventions.

In one aspect of the invention, a method is provided for determining the effect of a particular UTR sequence on mRNA stability, translation efficiency, and localization of a plurality of different nucleic acid segments. The method comprises: operably linking each of the plurality of different nucleic acid segments with a reporter sequence in an expression vector such that expression of the reporter sequence is under transcriptional control of a common promoter sequence and each of the different UTR nucleic acid sequences has been added to either the 5′ or 3′ end of the reporter sequence (yielding a hybrid transcript); expressing the reporter sequence; and determining the expression level of the reporter controlled by each of the different nucleic acid segments.

The present invention also provides compositions, assemblies of articles, and kits, preferably for carrying out the methods of the present invention. For example, an array of different gene expression regulatory elements is provided, preferably an array of different UTRs. The diversity of the array is a plurality, preferably at least 10, optionally at least 50, 80, 120, 160, 200, 400, 500, 600, 800, 1000, 1500, 2000, 3000, 5000, 8000, 10,000, or 25,000. Also provided are a library of expression vectors each of which comprises a different UTR, preferably operably linked with a reporter sequence such that overall expression (amount of protein produced) of the reporter sequence is under the control of each of the gene expression regulatory element. Examples of the different gene expression regulatory elements include, but are not limited to at least 2, optionally at least 5, 10, 20, 50, 100, 200, 500, 1000, 5000, 10000, or 25000 nucleotides selected from the group consisting of SEQ ID NOs: 1-17520 or fragments thereof. Examples of the reporter sequence include but are not limited to genes encoding luciferase, fluorescent protein (such as green fluorescent protein), and β-galactosidase.

In addition, kits are provided which comprise reagents and instructions for performing methods of the present invention, or for performing tests or assays utilizing any of the compositions, libraries, arrays, or assemblies of articles of the present invention. The kits may further comprise buffers, restriction enzymes, adaptors, primers, a ligase, a polymerase, dNTPS and instructions necessary for use of the kits.

In addition, the present invention provides a method for determining regulatory activity of a plurality of UTR regulatory elements in the genome of an individual. The method comprises: providing a nucleic acid sample from the individual; amplifying a predetermined region of a plurality of UTR regulatory elements in the genome to produce a plurality of nucleic acid fragments; inserting each of the nucleic acid fragments into a reporter construct to generate a library of hybrid reporter constructs; expressing the library of reporter constructs in cells; and determining the transcriptional and translational regulatory activity of the UTR regulatory elements in the cells by correlating with the levels of reporter expressed in the cells. The method may further comprise: comparing the regulatory activity of the UTR regulatory elements with a profile of the same UTR regulatory elements obtained from a reference sample. Examples of the plurality of UTR elements include, but are not limited to at least 2, optionally at least 5, 10, 20, 50, 100, 200, 500, 1000, 5000, 10000, or 25000 polynucleotides selected from the group consisting of SEQ ID NOs: 1-17520 or fragments thereof.

The method can be used for diagnosing a disease or condition associated with aberrant activity of a UTR regulatory element, such as beta-thalassemia, cardiovascular disease, Alzheimer disease, schizophrenia, bi-polar disorder, glaucoma, epilepsy, multiple sclerosis and lupus. The activity of a particular regulatory element, such as a UTR, or a panel of UTRs in the individual being tested can be compared with those of a panel of UTRs in a reference sample derived from the same individual or another individual. A difference in the regulatory activity may indicate that the individual being tested has a disease associated with aberrant UTR regulatory activity.

### Incorporation By Reference

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

We have developed two luciferase reporter vectors to enable high-throughput cloning of UTR sequences proximal to a luciferase reporter cassette. The vector also enables efficient shuffling of different promoters of varying strengths to drive the hybrid transcript to optimize detection of increased or decreased protein output.

FIG. 1 diagrams a 3′UTR expression vector in which nucleic acids ranging in size from 1 to 5,000 nucleotides representing 3′ UTR fragments are cloned into the multiple cloning site (MCS) 3′ to the reporter gene (luciferase) to produce a hybrid transcript that contains the reporter gene fused to the UTR of interest.

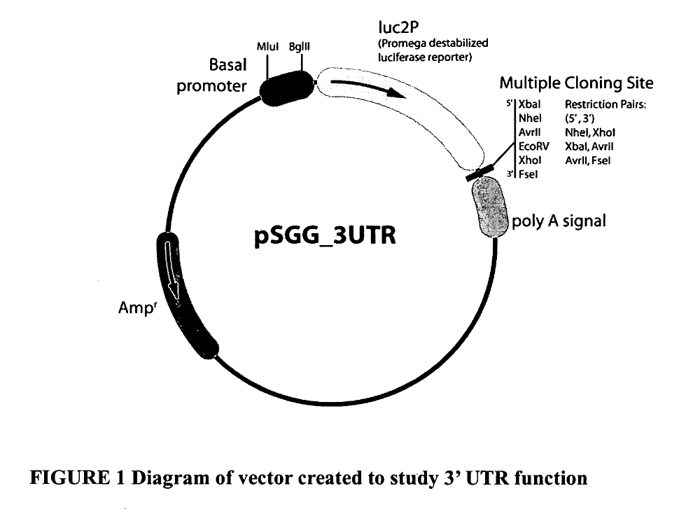

FIG. 2 diagrams a 5′UTR expression vector in which nucleic acids ranging in size from 1 to 5,000 nucleotides representing 5′ UTR fragments are cloned into the multiple cloning site (MCS) 5′ to the reporter (luciferase) gene to produce a hybrid transcript that contains the luciferase gene fused to the UTR of interest.

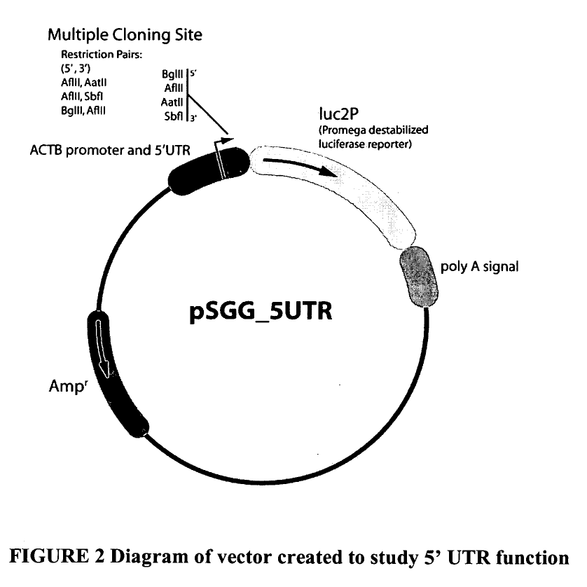

FIG. 3 depicts a method for producing a 3′ UTR expression construct of this invention. A gene in the genome encodes a gene comprising a transcribed region that includes a 5′ UTR, an open reading frame and a 3′ UTR. The 3′ UTR is amplified, e.g., by PCR. The amplified fragment is cloned into a multiple cloning site of a plasmid comprising ampicillin resistance. For example, fragments containing restriction sites can be ligated to the ends of the amplified sequence for this purpose. The expression construct comprises a transcription regulatory sequence (basal promoter) operatively linked to a segment comprising a reporter gene and the 3′UTR and a polyA signal. The expression construct produces an mRNA transcript comprising the open reading frame and the 3′ UTR. The translation of the open reading frame is regulated, in part, by regulatory sequences in the 3′ UTR.

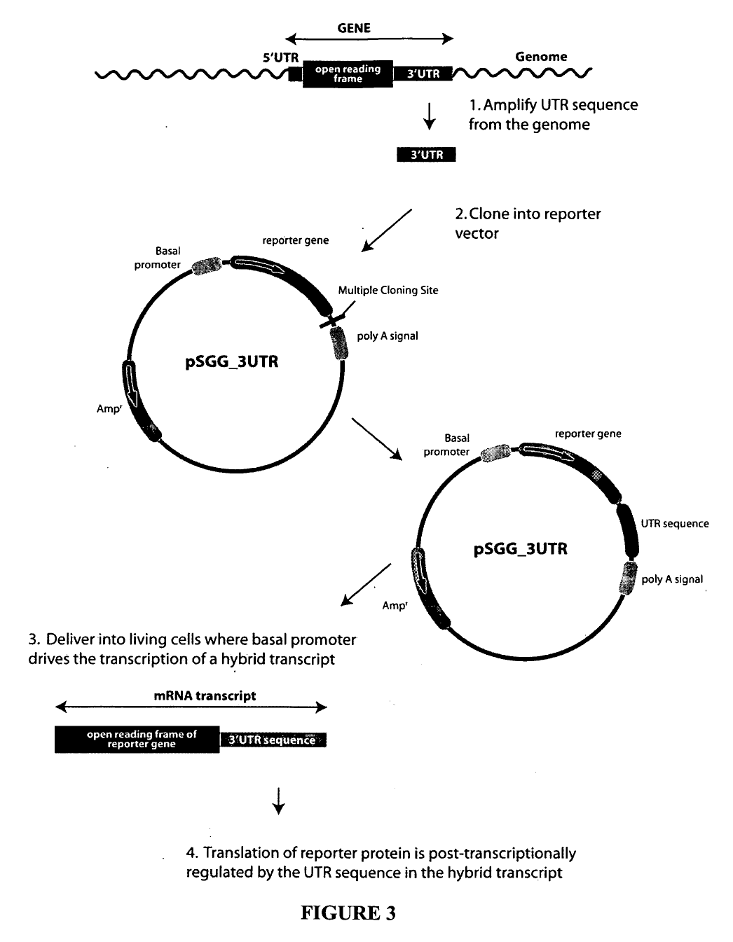

FIG. 4 is a table containing luciferase reporter data showing that the effect of DFO on luciferase output depends on the UTR present in the construct (hTR whole IRE, up IRE, or down IRE). The sequences of these UTR fragments are listed below the table.

FIG. 5 is a bar chart comparing how luciferase reporter constructs containing different hTR UTR versions function in the presence of DFO.

FIG. 6 is a bar chart comparing how luciferase reporter constructs containing different hTR UTR versions function in the absence of DFO.

FIG. 7 depicts an mRNA comprising a 5′ cap, a 5′ UTR, an open reading frame comprising a start codon, a coding region and a stop codon, a 3′ UTR and a poly A tail.

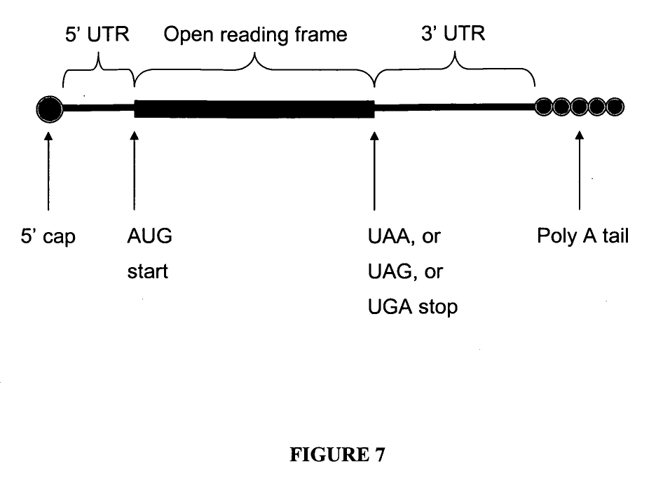

### DETAILED DESCRIPTION OF THE INVENTION

This invention provides expression constructs that allow determination of the regulatory activity of untranslated regions of mRNAs on the translation of open reading frames to which they are operably linked. The expression constructs of this invention comprise a transcription regulatory sequence (e.g., a promoter) operably linked to a nucleotide sequence that comprises a reporter gene and at least a portion of an untranslated nucleotide sequence from an mRNA. In these constructs, the UTR is operably linked with the reporter gene, so that any regulatory elements in the UTR regulate the translation, and, therefore, the expression, of the reporter gene, when transcribed under the control of the transcription regulatory sequence. Using transcriptional regulatory sequences of known function and reporter sequences of known activity allows controlled experiments to determine the function of the UTR on the translation of the reporter gene. In certain embodiments, the sequence from the UTR is a partial sequence of entire UTR, e.g., at least 10, at least 50, at least 100, at least 500 or at least 1000 nucleotides. In other embodiments, the UTR includes a majority of, at least 90%, at least 98% or the entire UTR of the mRNA that is its source.

This invention also provides libraries of the expression constructs of this invention. In certain embodiments each construct in the library contains a common transcriptional regulatory sequence, a common reporter gene and a different UTR, e.g., from a genome of a particular organism or species. In this way, when used in an expression system, differences in the expression of the reporter gene in each construct can be attributed to the activity of the UTR in that particular construct.

As used herein, an untranslated region (UTR) refers to any sequence in a mature mRNA transcript that does not code for the amino acids of a protein. The UTR typically includes the sequence upstream (5′) of a start codon, called the 5′ UTR, or downstream (3′) of the stop codon, called the 3′ UTR, of an open reading frame of an mRNA. The 3′ UTR does not include the poly A tail unless specified. Databases of mRNA sequences that can function as the source of the sequences for the UTRs include RefSeq (http://www.ncbi.nlm.nih.gov/RefSeq/), Mammalian Gene Collection (http://mgc.nci.nih.gov/), and the I.M.A.G.E Consortium (http://image.llnl.gov/).

UTR sequences often contain regulatory sequences that regulate the stability of the mRNA transcript, transport of the transcript, or the translation rates of the open reading frame contained in the transcript. Indeed, evidence continues to accumulate regarding the importance of 3′ UTR function in regulating transcript stability and localization along with playing a role in the regulation of translation (reviewed in Conne et al. 2000). 3′ UTRs are, on average, longer than 5′ UTRs in all genomes studied so far, and the average length of 3′ UTRs increases with organism complexity while the average length of 5′ UTRs remains roughly the same across a spectrum of species (Pesole et al. 2002; Mazumder et al. 2003). This and other data has led to speculation about the relative importance of the two types of UTR in post-transcriptional regulation. First, it has been suggested that the 5′ UTR's relatively short length, location, and likely structural constraints related to its standard role in transcription and translation initiation make it a less-rich element set for the study of gene-specific post-transcriptional regulation. Second, the 3′ UTR's apparent length flexibility and possible correlation with increasing organism complexity suggests that studies of the 3′ UTR are of high priority in the study of gene regulation. Finally, a number of recent studies have highlighted the importance of the combination of 3′ UTRs and miRNAs in gene regulation. For example, Xie et al. (2005) recently estimated that more than 40% of miRNAs interact with conserved motifs in 3′ UTRs. miRNAs are thought to regulate transcript stability by binding to a complementary sequence in an mRNA and targeting that transcript for degradation.

The scientific literature reveals a handful of genes for which studies of the function of both transcriptional and post-transcriptional regulatory elements have been carried out, and in all cases such studies have yielded valuable insight into that gene's regulation. One of the best-studied cases is that of the human Transferrin Receptor gene (hTR). hTR protein levels are known to increase more than 10-fold upon addition of an iron-chelator (DFO) to cells in culture. A panel of literature has shown that both the promoter and the 3′ UTR play necessary roles in mediating the change total protein output from the locus needed for an adequate response to iron depletion, and each is sufficient to supply moderate increases in gene expression response on its own (Casey et al. 1988; Mullner et al. 1988). An iron response element (IRE) has been characterized in the 3′ UTR of the hTR gene. The IRE forms a secondary stem-loop structure in the 3′ UTR of the hTR transcript, and there is a protein called the iron response element binding protein that recognizes and binds to this secondary structure. The binding of this protein to the IRE is thought to stabilize the hTR transcript and make it more readily available for translation.

Other combination functional studies include the globin gene family and a gene involved in cancer. Early mutagenesis studies of the beta-globin promoter indicated the importance of promoter function in proper regulation of the locus (Myers et al. 1986), and studies in subsequent years have revealed naturally occurring mutations in globin promoters that are associated with thalassemias (Collins et al. 1985; Kulozik et al. 1991). In addition, globin family mRNAs are known to be exceptionally stable, and functional studies of globin 3′ UTRs have revealed motifs essential to this stability (Weiss and Liebhaber 1995). A final example involves the CCND1 locus which is often involved in hematopoetic malignancies and its overexpression is known to cause a neoplastic pathology. Overexpression of CCND1 can result from either one of or the additive effect of two independent genetic events. In the first event, a common translocation places the transcription start site of the CCND1 locus within range of a strong transcriptional enhancer. In the second event, rearrangements and deletions in CCND1's 3′ UTR, often associated with genomic instability, act to increase the half-life of the mRNA (Rimokh et al. 1994).

The present invention relates to high throughput methods for structural and functional characterization of untranslated region (UTR) gene expression regulatory elements in a genome of an organism, preferably a mammalian genome, and more preferably a human genome. The inventive methods can be utilized as a high-throughput and easy-to-use system for characterization of UTR regulatory elements on a large scale, preferably on a genome-wide scale. Compositions, assemblies, libraries, arrays and kits are also provided to allow one to measure activity of the regulatory element in the genome in multiple experimental conditions in an efficient and economic way. In preferred embodiments, UTR macroarrays and microarrays are provided for determining RNA-binding factor binding and UTR regulatory activity on the same DNA fragment. Such functional libraries or arrays of the UTR regulatory elements can have a wide variety of applications in research, diagnosis, prevention and treatment of diseases or conditions.

In one aspect, by using the invention, activity of a large number of different UTR regulatory elements can be assessed or determined across diverse cell types or through a differentiation time-course to find tissue-specific and ubiquitous UTR regulatory sequences. The activity of the UTR regulatory elements can be detected or determined under different conditions, such as before and after the addition of an siRNA, microRNA, cDNA, or other compound or drug to identify elements that are up-regulated or down-regulated in response to a specific treatment. Effects of RNA-binding factors binding to the UTR regulatory element can also be assessed efficiently. The collection of these UTR regulatory elements can be further analyzed for a sequence motif that is functionally relevant.

In another aspect this invention provides a library of isolated nucleic acid molecules, each member of the library comprising a different, pre-determined nucleic acid segment from a genome, wherein the segment comprises UTR regulatory sequences, wherein: (a) the library has a diversity of at least 50 different nucleic acid segments; and (b) each nucleic acid segment is naturally linked in the genome with a sequence expressed as a cDNA.

In another aspect this invention provides a library of expression constructs, each member of the library comprising a different nucleic acid segment from a genome, wherein the segment comprises UTR regulatory sequences, operably linked with a heterologous reporter sequence in an expression vector such that the reporter gene transcript produced from the vector includes a UTR regulatory sequence, and the expression of the reporter gene protein is regulated by the UTR sequence that affects mRNA stability, translation efficiency, and localization, wherein: (a) the library has a diversity of at least 50 different nucleic acid segments; and (b) each nucleic acid segment and is naturally linked in the genome with a sequence expressed as a cDNA.

A number of different transcriptional regulatory elements can be used to drive expression of the hybrid transcript containing a UTR fragment. A ubiquitously active transcriptional promoter is of general utility to provide consistent levels of expression across many different cell lines and conditions. Viral promoters that are expressed ubiquitously also are usefull. Promoters of housekeeping genes, e.g., genes involved in the basal metabolism and functioning of cells, such as beta actin (ACTB), glyceraldehyde-3-phosphate dehydrogenase (GAPDH), ribosomal proteins such as “ribosomal protein, large subunit 10” (RPL10—used in the Examples herein), and thymidine kinase (TK1—“thymidine kinase 1”) have been shown to serve this purpose. In some cases, very strong promoters may be useful to drive high levels of expression in order detect UTR activity that down-regulates reporter gene activity. A strong promoter causes expression of a reporter gene at levels at least 1000 times above background. Conversely, in some cases weak promoters that drive low levels of expression may be useful to detect UTR activity that up-regulates reporter gene activity. A weak promoter causes expression of a reporter gene at levels between 10 times and 50 times above background. In some specific cases, it may also be useful to use a tissue or cell-type specific promoter to drive expression in a limited number of cell types of interest.

In one embodiment the step of providing the device comprises: (i) providing a device comprising at least one plate comprising a plurality of wells, each well containing a different member of the library of expression constructs, wherein each member of the library of expression constructs has a known location among the wells; (ii) delivering cells to each of the wells; and (iii) transfecting the cells with the expression constructs. In another embodiment the method further comprises: (d) perturbing the cells in each well; (e) measuring the level of expression of the reporter sequence in each well; and (f) determining whether the level of expression in any well changed after contacting the cells with the test compound. In another embodiment of the method perturbing comprises contacting the cells in each well with a test compound, exposing the cells to different environmental conditions, or genetically modifying the cells either permanently or transiently such as by inducing mutation, overexpressing a transcript for example by transfecting with a cDNA decreasing expression of a transcript by siRNA, or altering levels of a microRNA in the cell.

While not wishing to be bound by theory, it is believed that functional assays are important because although experimental tools like expression microarrays and RNA immunoprecipitation produce valuable observations, they do not explain the mechanism or function of the DNA or RNA regulatory elements themselves. Functional data from UTRs can show that changes in UTR activity and thus changes in rates of RNA turnover or localization result in different transcript levels detected in a microarray experiment rather than transcription initiation mechanisms. In addition, some UTR sequences may effect the rate at which a particular transcript is translated into a mature protein, thus affecting the total protein output without disrupting steady-state levels of the transcript. Such changes in protein output will not be detected by using an expression microarray. Furthermore, the UTR functional assay localizes the activity of interest to a specific RNA fragment and enables the discovery of the exact functional motifs contained in that region.

It is also believed that any one experimental platform alone is not sufficient to fully describe a biological system. A gene may be highly expressed as measured by a microarray based on nucleic acid hybridization, but it cannot be determined why. A transcription factor may bind near a particular gene in the genome, but the functional consequences of binding cannot be determined. A stretch of sequence may be highly conserved, but the reason natural selection has acted to preserve this sequence is unknown. A promoter may be methylated in one cell type and unmethylated in another, but the functional consequences of this difference is not immediately clear. In addition, a UTR may show increased RNA turnover activity in a cell-based functional assay upon the addition of a compound, but one can only make guesses as to why its activity changed without other lines of experimental evidence. Each experimental approach also has its own inherent biases and unique issues related to that particular approach. Thus, the inventors believe that when researchers integrate the information gathered from many diverse techniques they are able to gain a full picture of a biological system, independent of the limitations specific to any one experiment.

The present invention provides an innovative methodology and products to facilitate an integrated approach to regulatory element network analysis and use the information generated therefrom for researching the molecular genetic mechanisms of predisposition, onset and/or development of diseases, for development of effective measures for diagnosis, prevention and treatment of diseases.

In a preferred embodiment, an array of diverse, different gene expression regulatory elements is provided, preferably an array of different UTRs. The diversity of the array is preferably at least 10, optionally at least 50, 80, 120, 160, 200, 400, 500, 600, 800, 1000, 1500, 2000, 3000, 5000, 8000, or 10,000. Also provided are a library of expression vectors each of which comprises a different UTR regulatory element, preferably operably linked with a reporter sequence such that transcript stability and translational efficiency of the hybrid reporter transcript is under the control of each of the UTR regulatory element.

In another embodiment, a highly diverse array of expression vectors is provided which comprise at least 20 different gene expression regulatory elements in the expression vectors. The functional arrays of this invention are useful for performing high-throughput experiments to screen activity of the UTR regulatory sequences of this invention. The increase in throughput provided by these arrays of UTR expression vectors and functional assays is important for several reasons.

First, removing limits on the numbers of regulatory elements that can be assayed in a single panel allows researchers to interrogate elements corresponding to entire biological networks in a single experiment. For example, there are well over a thousand genes that are implicated in cancer development and progression. By scaling the UTR functional assays to include UTRs of over a hundred of genes, for example over a thousand genes, researchers can study all of the UTRs of all cancer related genes at once.

Increasing throughput will also enable the study of UTR sequence variants on a much larger scale. Since each UTR in the genome will likely have several SNPs on average, increasing the throughput will allow a comprehensive analysis of all existing haplotypes of a given set of UTRs rather than having to pick the most common haplotypes.

Further, assaying a large number of regulatory elements in a single experiment will allow researchers to conduct statistical analyses with much greater power. The previous UTR activity experiments have shown that UTR activity data often breaks down into clusters of similar activity, just like gene clusters in microarray expression experiments. In an experiment with a small number of UTRs, each sub-cluster is often too small to make any statistically significant claims as to important features unique to that cluster, such as the over-representation of certain motifs or higher-order sequence characteristics. The larger the dataset, the more power there is to perform these statistical analyses; and a diversity of UTRs beyond 200 or 1,000 in a single panel would be very desirable.

This invention provides a library of genomic nucleic acid segments comprising UTR regulatory elements. Each genomic nucleic acid segment selected for the library is operatively linked in nature with a coding sequence in the genome that aligns with a known or newly identified cDNA molecule.

In preferred embodiments, the regulatory element is a UTR regulatory element. Each of the regulatory elements can be characterized in terms of its genomic location, sequence, variation, mutation, polymorphism, transcriptional or translational regulatory activity in different cell or tissue type, and binding affinity with other regulatory factors, such as RNA-binding factors. Information on the structure and function of the gene expression regulatory elements can have a wide variety of applications, including but not limited to diagnosis and treatment of diseases in a personalized manner (also known as “personalized medicine”) by association with phenotype such as disease resistance, disease susceptibility or drug response. Identification and characterization of the regulatory elements in terms of cell- or tissue-specificity can also aid in the design of transgenic expression constructs for gene therapy with enhanced therapeutic efficacy and reduced side effects. “Disease” includes but is not limited to any condition, trait, or characteristic of an organism that it is desirable to change. For example, the condition may be physical, physiological or psychological and may be symptomatic or asymptomatic.

In one aspect of the invention, a method is provided for determining transcriptional and translational regulatory activity of a plurality of different nucleic acid segments. The method comprises: operably linking each of the plurality of different nucleic acid segments with a reporter sequence in an expression vector such that transcript stability and translational efficiency of the hybrid reporter transcript is under the control of each of the UTR regulatory elements.

The plurality of different nucleic acid segments are preferably DNA segments derived from the 5′ or 3′ UTRs of different genes. The diversity of the plurality of different nucleic acid segments can be at least 10, optionally at least about 50, 80, 120, 160, 200, 400, 500, 600, 800, 1000, 1500, 2000, 3000, 5000, 8000, or 10,000. Examples of the plurality of different nucleic acid segments include, but are not limited to at least 2, optionally at least 5, 10, 20, 50, 100, 200, 500, 1000, 5000, 10000, or 25000 nucleotides selected from the group consisting of SEQ ID NOs: 1-17520, or fragments thereof.

The plurality of different DNA segments can be derived from the 5′ and 3′ UTR regions of different genes by using a computer-aided method for predicting putative gene expression regulatory elements, such as UTRs. The computer-aided method comprises: aligning a library of cDNA for different genes with a genome of an organism; defining transcription start and end sites along with coding regions for each of the different genes; and selecting a segment in the genome that comprises a UTR, the selected segment constituting a member of the plurality of different DNA segments. A detailed explanation of UTR identification is provided in Example 1.

The methods of the present invention for selecting putative gene expression regulatory elements can be implemented in various configurations in any computing systems, including but not limited to supercomputers, personal computers, personal digital assistants (PDAs), networked computers, distributed computers on the internet or other microprocessor systems. The methods and systems described herein above are amenable to execution on various types of executable mediums other than a memory device such as a random access memory (RAM). Other types of executable mediums can used, including but not limited to, a computer readable storage medium which can be any memory device, compact disc, zip disk or floppy disk.

The present invention also provides compositions, assemblies, and kits, preferably for carrying out the methods of the present invention. For example, an array of different gene expression regulatory elements is provided, preferably an array of different UTRs. The diversity of the array is preferably at least at least 10, optionally at least 50, 80, 120, 160, 200, 400, 500, 600, 800, 1000, 1500, 2000, 3000, 5000, 8000, or 10,000. The UTRs can be selected from the group consisting of SEQ ID NOs: 1-17520, or fragments thereof. Also provided are a library of expression vectors each of which comprises a different UTR element, preferably operably linked with a reporter sequence such that expression of the reporter sequence is under transcriptional and translational control of each of the UTR. Examples of the reporter sequence include but are not limited to genes encoding luciferase, fluorescent protein (such as green fluorescent protein), and β-galactosidase.

The present invention also provides a library of gene expression regulatory elements, preferably a library of UTRs, preferably with diversity of at least 10, optionally at least 50, 80, 120, 160, 200, 400, 500, 600, 800, 1000, 1500, 2000, 3000, 5000, 8000, or 10,000. Examples of the UTRs include, but are not limited to, at least 2, optionally at least 5, 10, 20, 50, 100, 200, 500, 1000, 5000, 10000, or 25000 nucleotides selected from the group consisting of SEQ ID NOs: 1-17520, or fragments thereof.

The UTR library (or the regulatory element library) may exist in an in silico form and a physical form. The in silico form is a database of sequences from the human genome representing UTRs and related genomic information such as the gene model and transcript it is associated with. The physical form of the UTR library may be a set of a plurality of individual nucleic acid fragments of the UTRs, or plasmids each of which contains a unique UTR fragment from the human genome that is cloned either 5′ or 3′ to a reporter gene cassette thus yielding a hybrid transcript of the common reporter gene with a unique UTR.

The physical form of the UTR library may be represented in several ways. One form may be as an archived library of plasmids that are frozen in small E. coli cultures. These frozen cultures can be stored indefinitely and expanded in liquid culture to produce more of the plasmids. Another form of the library may be purified plasmid DNAs that can be immediately ready for transfection. Based on the library of gene expression regulatory elements, preferably a library of UTRs, a wide variety of tools or kits can be built, such as plasmid functional macroarrays and spotted UTR microarrays, which are described below.

The UTR library includes a panel of plasmids, each made up of a common vector/plasmid backbone with a unique insert representing a single UTR from the human genome. The UTR fragment may be cloned immediately 5′ or 3′ to a reporter gene cassette to be included in the transcript. This library can be a starting point from which two types of arrays: a plasmid functional macroarray and a spotted UTR microarray are built.

The plurality of different DNA segments can be derived from the 5′ or 3′ untranslated regions of different genes by using a computer-aided method for predicting UTRs. The computer-aided method comprises: aligning a library of cDNA for different genes with a genome of an organism; defining transcription start and end sites along with coding regions for each of the different genes; and selecting a segment in the genome that comprises a UTR, the selected segment constituting a member of the plurality of different DNA segments.

In another embodiment, this invention provides libraries of expression constructions comprising the genomic segments of this invention. The library comprises a collection of members, each of which contains a different nucleic acid segment from the genome. The expression constructs are recombinant nucleic acid molecules comprising a nucleic acid segment of this invention operably linked with a heterologous reporter sequence. A nucleotide sequence is operably linked with an expression control sequence when the nucleotide sequence is under the transcriptional or translational regulatory control of the expression control sequence. The reporter sequence is heterologous to the genomic segment in that it is not naturally under the transcriptional regulatory control of the genomic segment sequence in the genome from which the nucleic acid segment comes. This recombinant nucleic acid molecule is further comprised within a vector that can be used to either infect or transiently or stably transfect cells and that may be capable of replicating inside a cell.

This invention contemplates a number of different reporter sequences that may be under the control of the transcript stability or translational regulatory elements of the genomic segments. In libraries using proteins that emit a detectable signal it may be useful, but not essential, for all of the reporter proteins to emit the same signal. This simplifies detection during high-throughput methods.

Alternatively, the expression constructs in the library may contain different reporter sequences which emit different detectable signals. For example, the reporter sequence in each of the constructs can be a unique, pre-determined nucleotide barcode. This allows assaying a large number of the nucleic acid segments in the same batch or well of cells. In an embodiment, in each construct a unique UTR sequence is cloned upstream or downstream of a unique barcode reporter sequence yielding a unique UTR/barcode hybrid reporter transcript combination. Thus, in a library of expression constructs, each UTR's activity affects the transcript stability and localization of a unique transcript whose level can be measured. Since each reporter is unique, the library of expression constructs can be transfected into one large pool of cells (as opposed to separate wells) and all of the RNAs may be harvested as a pool. The levels of each of the barcoded transcripts can be detected using a microarray with the complementary barcode sequences. So the amount of fluorescence on each array spot corresponds to the effect of the UTR on the nucleotide barcode's transcript stability or localization.

Optionally, the expression constructs in the library may contain a first reporter sequence and a second reporter sequence. The first reporter sequence and a second reporter sequence are preferred to be different. For example, the first reporter sequence may encode the same reporter protein (e.g., luciferase or GFP), and the second reporter sequence may be a unique nucleotide barcode. In this way, transcription can yield a hybrid transcript of a reporter protein coding region and a unique barcode sequence. Such a construct could be used either in a well-by-well approach for reading out the signal emitted by the reporter protein (e.g., luminescence) and/or in a pooled approach by reading out the barcodes.

By using the unique, molecular barcode for each member of the library, a large library (e.g. a library with diversity of at least 100, 150, 200, 500, 1000, 2000, or 25,000) can be assayed in a single container (such as a vial or a well in a plate) rather than in thousands of individual wells. This approach is more efficient and economic as it can reduce costs at all levels: reagents plasticware, and labor.

The expression construct may be any vector that facilitates expression of the reporter sequence in the construct in a host cell. Any suitable vector can be used. There are many known in the art. Examples of vectors that can be used include, for example, plasmids or modified viruses. The vector is typically compatible with a given host cell into which the vector is introduced to facilitate replication of the vector and expression of the encoded reporter. Examples of specific vectors that may be useful in the practice of the present invention include, but are not limited to, E. coli bacteriophages, for example, lambda derivatives, or plasmids, for example, pBR322 derivatives or pUC plasmid derivatives; phage DNAs, e.g., the numerous derivatives of phage 1, e.g., NM989, and other phage DNA, e.g., M13 and filamentous single stranded phage DNA; yeast vectors such as the 2 μ plasmid or derivatives thereof; vectors useful in eukaryotic cells, for example, vectors useful in insect cells, such as baculovirus vectors, vectors useful in mamnalian cells such as retroviral vectors, adenoviral vectors, adenovirus viral vectors, adeno-associated viral vectors, SV40 viral vectors, herpes simplex viral vectors and vaccinia viral vectors; vectors derived from combinations of plasmids and phage DNAs, plasmids that have been modified to employ phage DNA or other expression control sequences; and the like.

In another aspect this invention provides recombinant cells comprising the expression libraries of this invention. Two different embodiments are contemplated in particular.

In a first embodiment each cell or group of cells comprises a different member of the expression library. Such a library of cells is particularly useful with the arrays of this invention. Typically, the library is indexed. For example, each different cell harboring a different expression vector can be maintained in a separate container that indicates the identity of the genomic segment within. The index also can indicate the particular gene or genes that is/are under the transcriptional or translational regulatory control of the sequences naturally in the genome.

In a second embodiment, a culture of cells is transfected with a library of expression constructs so that all of the members of the library exist in at least one cell and each cell has at least one member of the expression library. The second embodiment is particularly useful with libraries in which the reporter sequences are unique sequences that can be detected independently.

Useful cell types include primary and transformed mammalian cell lines to which exogenous DNA may be introduced by lipofection, electroporation, or infection. Libraries in such cells may be maintained in growing cultures in appropriate growth media or as frozen cultures supplemented with Dimethyl Sulfoxide and stored in liquid Nitrogen.

In another aspect, this invention provides devices comprising multiwell plates, also called macroarrays, each well of which contains a different member of expression library of this invention. While this invention contemplates multiwell plates in a variety of formats and array layouts, there are a number of standard formats well known in the art. In particular, it is contemplated that a library of expression vectors can be contained within the wells of one or more 96-well, 384-well or 1536-well microtiter plates.

In a preferred embodiment, an array of diverse, different gene expression regulatory elements is provided, preferably an array of different transcriptional promoters. The diversity of the array is preferably at least at least 10, optionally at least 50, 80, 120, 160, 200, 400, 500, 600, 800, 1000, 1500, 2000, 3000, 5000, 8000, 10,000, or 25,000 nucleotides selected from the group consisting of SEQ ID NOs: 1-17520, or fragments thereof. Also provided are a library of expression vectors each of which comprises a different UTR regulatory element, preferably operably linked with a reporter sequence such that transcript stability and translational efficiency of the hybrid reporter transcript is under the control of each of the UTR regulatory element.

For the plasmid functional macroarray, each member of the UTR library may be transfected separately into E. coli. Each E. coli stock may be grown up to make >100 ug of each plasmid and then the plasmid DNAs are purified from the rest of the parts of the bacterial cells. Small aliquots of each plasmid (with appropriate transfection reagents) may be arrayed in a 96-well, 384-well, or 1536-well format. This macroarray of plasmids can be used for a number of different applications. Its primary use is preferably in the transfection of living cells. Once the plasmids are delivered to living cells, the amount of activity detected from the reporter gene product reflects the transcript stability and translation efficiency effects provided by the UTR fragment. Thus, the plasmid macroarray enables the high-throughput study of UTR function in living cells. UTR functional assays may be conducted in a variety of cell types, in response to a change in the cellular environment, in response to an alteration in a gene sequence or function, or in the presence of a small molecule or protein sequence of interest.

In one embodiment, this invention contemplates microtiter arrays in which the wells contain expression vectors outside of a cellular environment. In particular, microtiter arrays are contemplated in which each well contains an expression vector of this invention in dried form. Such devices can be stored and shipped easily and are ready for use. In other embodiments the wells contain a solution comprising the nucleic acids. In another embodiment, the solution can contain all the elements necessary for transfecting cells that are added to the plates.

Microtiter arrays in which each well comprises a recombinant cell containing an expression vector of this invention are useful for carrying out high-throughput screening assays. To generate such arrays, DNA may be mixed with serum-free media and a transfection reagent (such as a lipofection reagent), incubated, and added to a group of cells. After an incubation time, the exogenous DNA will be present in the cells. Alternate methods for delivery include electroporation and infection.

In an embodiment, a kit is provided for a functional macroarray of UTRs. The kit includes: transfection-ready set of UTR plasmids arrayed in 96 or 384 wells. The kit may further include: reporter assay substrates; reagents for induction or repression of a particular biological pathway (cytokines or other purified proteins, small molecules, cDNAs, siRNAs, etc.), and/or data analysis software.

In addition, kits are provided which comprise reagents and instructions for performing methods of the present invention, or for performing tests or assays utilizing any of the compositions, libraries, arrays, or assembles of articles of the present invention. The kits may further comprise buffers, restriction enzymes, adaptors, primers, a ligase, a polymerase, dNTPS and instructions necessary for use of the kits, optionally including troubleshooting information.

In another embodiment, a kit is provided for a RNA immunoprecipitation assay. The kit includes: a spotted UTR microarray or UTR-specific oligo-based microarray; and one or more immunoprecipiatation-grade antibody. The kit may further include: DNA/RNA amplification and labeling reagents; and/or data analysis software.

In still another embodiment, an assembly of articles is provided for a comprehensive UTR analysis, comprising: a plasmid functional macroarray kit and a UTR microarray kit for RNA immunoprecipitation. The assembly may further include: analysis software for data integration.

Methods of Use

In one aspect of the invention, a method is provided for determining UTR regulatory activity of a plurality of different nucleic acid segments. The method comprises: operably linking each of the plurality of different nucleic acid segments with a reporter sequence in an expression vector such that expression of the reporter sequence is under transcriptional control of a common promoter sequence and each of the different UTR nucleic acid sequences has been added to either the 5′ or 3′ end of the reporter sequence (yielding a hybrid transcript); expressing the reporter sequence; and determining the expression level of the reporter controlled by each of the different nucleic acid segments.

A multiwell plate array of cell harboring the expression constructs of this invention is useful for high-throughput screening of UTR activity. In the basic method, a multiwell plate having a member of an expression library of this invention in each well is filled with a cell type of interest under conditions so that the cells are transfected with the vectors. The cells are then incubated under conditions chosen by the operator. The investigator then checks each well of the device to measure the amount of reporter protein produced. Generally, this involves measuring the signal produced by a reporter protein encoded by the reporter sequence. For example, if the reporter protein is a fluorescent protein, then light is directed to each well and the amount of fluorescence is measured. The amount of signal measured is a function of the effect of the UTR on transcript stability and translation efficiency.

By expanding from 96-well plates to 384-well plates and pre-aliquoting the plasmid DNAs, throughput can be expanded from hundreds to >1,000 UTR assays in a single experiment. Scaling this experiment to more than 1,000 independent UTR fragments greatly improves the scope of the research project and gives more power to the downstream statistical analyses of these data. The larger the dataset, the more amenable it is to approaches such as principle component analysis and hierarchical clustering. By studying more than 1,000 UTRs at once in multiple experiments, sub-clusters of UTR activity data are large enough to look for over-represented motifs or higher-order sequence characteristics.

In another embodiment of the methods of this invention, the investigator can test the effect of a system perturbation on the activity of a library of UTR regulatory sequences. The basic method described above is performed under a first set of conditions to determine the effect of the UTRs on overall reporter expression. Then the cells are perturbed, i.e., subject to different conditions, in a manner chosen by the investigator. Perturbations can include, for example, exposing the cells to a test compound, changing environmental conditions such as temperature, pH or nutrition, or genetically modifying the cells to introduce new or modified genetic material or changes in amounts of genetic material. After perturbation, the amount of reporter protein output associated with each UTR in the library is examined and compared to its activity in the first state. UTRs that show altered activity can be isolated and studied further. In this way it can be determined, for example, which UTR regulatory sequences have their activity modulated by a compound of interest.

In a variation of this method, the test is performed in parallel. That is, two identical devices of this invention are examined for UTR activity. However, one device is subjected to a first set of conditions and the other device is subjected to a second set of conditions. In this way, the relative activity of the UTR regulatory sequences under the two conditions can be examined, and sequences that have different activity can be identified and isolated.

It also can be useful to identify differences in UTR regulatory sequence activity in two cell types. For example gene expression differs when cells transform from normal to cancerous. UTRs that are overactive in cancer cells may be targets of pharmacological intervention. The arrays of this invention are useful to identify such UTR regulatory sequences. Accordingly, the investigator provides two sets of arrays comprising expression constructs in the wells. Once cell type is used for transformation in a first device and a second cell type, for transformation in a second device. The expression of reporter sequences between the two devices is compared to identify those UTRs which be have differently in the two cell types.

Using expression constructs in which the UTR regulatory sequences are operably linked to unique reporter sequences opens the possibility of performing tests without the use of multiwell plates. In such situations a single culture of cells contains the entire expression library distributed among the cells. The culture can be incubated under conditions chosen by the investigator. Then the expression products are isolated. As described in the section entitled “Reporter Sequences” because each one has a unique nucleotide sequence tag or barcode associated with its partner nucleic acid segment, the amount of each of the reporter sequences can be measured by measuring the amount of transcript comprising each unique sequence. For example, the molecules can be detected on a DNA array that contains probes complementary to the unique sequences. The amount of hybridization to each probe indicates the amount of the reporter sequence expressed, which, in turn, reflects the activity of the UTR regulatory sequences.

There are many published accounts of sequence changes in UTR regions causing changes in human phenotypes or disease status. Association studies and efforts such as the Hap-Map project often detect potentially biologically interesting variation in the sequences of UTRs between individuals in the human population. The significant questions then revolve around whether or not those sequence changes actually affect the function of the UTR or if they are essentially silent, non-functional changes. The assays provided herein can be used to compare the activity of UTR variants.

This invention provides methods for identifying variants in UTR regulatory sequences that are associated with phenotypic differences in a population. The methods involve the following steps. First, one identifies and selects UTR regulatory sequences that exhibit sequence polymorphism in a population, such as SNPs, from a database of sequences or other information source. Then, one tests these variants for transcript stability and translation efficiency activity in an assay of this invention. Polymorphic forms that exhibit differences in activity in these assays are selected for further study. In such a study, two populations are selected that have different phenotypic traits. For example, a first population having a disease and a second population not having the disease are selected. Generally, the investigator will select a UTR that regulates expression of a gene suspected to have some connection with the phenotype in question. The population is large enough to provide statistically significant results. Each individual in the two populations are then tested to determine which form of the variant the individual has. Statistical analysis will indicate whether the polymorphic form is associated with the phenotype. Polymorphic forms found to associate with a specific phenotype then can be used in diagnostic tests to determine how likely it is that the individual has the phenotype.

More generally, the products provided in the present invention can also be used to correlate polymorphisms in a UTR regulatory element with a phenotypic trait more efficiently. Correlation of individual polymorphisms or groups of polymorphisms with phenotypic characteristics is a valuable tool in the effort to identify DNA variation that contributes to population variation in phenotypic traits. Phenotypic traits include physical characteristics, risk for disease, and response to the environment. Polymorphisms that correlate with disease are particularly interesting because they represent mechanisms to accurately diagnose disease and targets for drug treatment. Hundreds of human diseases have already been correlated with individual polymorphisms but there are many diseases that are known to have an, as yet unidentified, genetic component and many diseases for which a component is or may be genetic.

Many diseases may correlate with multiple genetic changes making identification of the polymorphisms associated with a given disease more difficult. One approach to overcome this difficulty is to systematically explore the limited set of common gene variants for association with disease. The functional studies enabled by a regulatory element macroarray will facilitate the sorting out of sequence variants that affect the function of a regulatory element away from those that do not. Therefore, researchers may look for correlation of functional sequence variants with phenotypic traits, changing the focus from finding variants merely correlated with a phenotype towards identifying variants that may cause a particular phenotype.

To identify correlation between one or more alleles in the UTR regulatory region and one or more phenotypic traits, individuals are tested for the presence or absence of polymorphic markers or marker sets and for the phenotypic trait or traits of interest. The presence or absence of a set of polymorphisms is compared for individuals who exhibit a particular trait and individuals who exhibit lack of the particular trait to determine if the presence or absence of a particular allele is associated with the trait of interest. For example, it might be found that the presence of allele A1 at polymorphism A in the UTR region of a gene correlates with heart disease. As an example of a correlation between a phenotypic trait and more than one polymorphism, it might be found that allele A1 at polymorphism A and allele B1 at polymorphism B correlate with a phenotypic trait of interest.

Markers or groups of markers in a UTR regulatory region that correlate with the symptoms or occurrence of disease can be used to diagnose disease or predisposition to disease without regard to phenotypic manifestation. To diagnose disease or predisposition to disease, individuals are tested for the presence or absence of polymorphic markers or marker sets that correlate with one or more diseases. If, for example, the presence of allele A1 at polymorphism A correlates with coronary artery disease then individuals with allele A1 at polymorphism A may be at an increased risk for the condition.

Individuals can be tested before symptoms of the disease develop. Infants, for example, can be tested for genetic diseases such as beta-thalassemia at birth. Individuals of any age could be tested to determine risk profiles for the occurrence of future disease. Often early diagnosis can lead to more effective treatment and prevention of disease through dietary, behavior or pharmaceutical interventions. Individuals can also be tested to determine carrier status for genetic disorders. Potential parents can use this information to make family planning decisions.

Individuals who develop symptoms of disease that are consistent with more than one diagnosis can be tested to make a more accurate diagnosis. If, for example, symptom S is consistent with diseases X, Y or Z but allele A1 at polymorphism A correlates with disease X but not with diseases Y or Z an individual with symptom S is tested for the presence or absence of allele A1 at polymorphism A. Presence of allele A1 at polymorphism A is consistent with a diagnosis of disease X.

In addition, the products provided in the present invention can also be used for pharmacogenonics. Pharmacogenomics refers to the study of how your genes affect your response to drugs. There is great heterogeneity in the way individuals respond to medications, in terms of both host toxicity and treatment efficacy. There are many causes of this variability, including: severity of the disease being treated; drug interactions; and the individuals age and nutritional status. Despite the importance of these clinical variables, inherited differences in the form of genetic polymorphisms can have an even greater influence on the efficacy and toxicity of medications. Genetic polymorphisms in drug-metabolizing enzymes, transporters, receptors, and other drug targets have been linked to inter-individual differences in the efficacy and toxicity of many medications. The functional studies enabled by a regulatory element macroarray will facilitate the sorting out of sequence variants that affect the function of a regulatory element away from those that do not. Therefore, researchers may look for correlation of functional sequence variants with phenotypic traits, changing the focus from finding variants merely correlated with a phenotype towards identifying variants that may cause a particular phenotype.

In a manner similar to that above, UTR regulatory sequences in genes suspected to be involved in drug metabolism are screened to identify those that exist in polymorphic forms in a population. These sequences are tested for functional differences in the assays of this invention. Those that exhibit functional differences are then examined in populations having different responses to a drug to determine whether a polymorphic form is associated with differences in drug reaction.

An individual patient has an inherited ability to metabolize, eliminate and respond to specific drugs. Correlation of polymorphisms in a UTR regulatory region with pharmacogenomic traits identifies those polymorphisms that impact drug toxicity and treatment efficacy. This information can be used by doctors to determine what course of medicine is best for a particular patient and by pharmaceutical companies to develop new drugs that target a particular disease or particular individuals within the population, while decreasing the likelihood of adverse affects. Drugs can be targeted to groups of individuals who carry a specific allele or group of alleles. For example, individuals who carry allele A1 at polymorphism A may respond best to medication X while individuals who carry allele A2 respond best to medication Y. A trait may be the result of a single polymorphism but will often be determined by the interplay of several genes.

In addition some drugs that are highly effective for a large percentage of the population, prove dangerous or even lethal for a very small percentage of the population. These drugs typically are not available to anyone. Pharmacogenomics can be used to correlate a specific genotype with an adverse drug response. If pharmaceutical companies and physicians can accurately identify those patients who would suffer adverse responses to a particular drug, the drug can be made available on a limited basis to those who would benefit from the drug.

Similarly, some medications may be highly effective for only a very small percentage of the population while proving only slightly effective or even ineffective to a large percentage of patients. Pharmacogenomics allows pharmaceutical companies to predict which patients would be the ideal candidate for a particular drug, thereby dramatically reducing failure rates and providing greater incentive to companies to continue to conduct research into those drugs.

The present invention relies on many patents, applications and other references for details known to those of the art. Therefore, when a patent, application, or other reference is cited or repeated below, it should be understood that it is incorporated by reference in its entirety for all purposes as well as for the proposition that is recited. As used in the specification and claims, the singular form “a,” “an,” and “the” include plural references unless the context clearly dictates otherwise. For example, the term “an agent” includes a plurality of agents, including mixtures thereof An individual is not limited to a human being but may also be other organisms including but not limited to mammals, plants, bacteria, or cells derived from any of the above.

Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible subranges as well as common individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. The same holds true for ranges in increments of 10⁵, 10⁴, 10³, 10², 10, 10⁻¹, 10⁻², 10⁻³, 10⁻⁴, or 10⁻⁵, for example. This applies regardless of the breadth of the range. “At least” in combination with a series of numbers means at least any of the series.

The practice of the present invention may employ, unless otherwise indicated, conventional techniques of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example hereinbelow. However, other equivalent conventional procedures can, of course, also be used. Such conventional techniques can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), all of which are herein incorporated in their entirety by reference for all purposes.

Definitions

As used herein, the term “nucleic acid” refers to single-stranded and/or double-stranded polynucleotides such as deoxyribonucleic acid (DNA), and ribonucleic acid (RNA) as well as analogs or derivatives of either RNA or DNA. Also included in the term “nucleic acid” are single-stranded and/or double-stranded polynucleotides as normally found in nature (“natural nucleic acids”), e.g., methylated nucleic acid or unmethylated nucleic acid. Also included in the term “nucleic acid” are analogs of nucleic acids such as peptide nucleic acid (PNA), phosphorothioate DNA, and other such analogs and derivatives or combinations thereof. Thus, the term also should be understood to include, as equivalents, derivatives, variants and analogs of either RNA or DNA made from nucleotide analogs, single (sense or antisense) and double-stranded polynucleotides, including double-stranded RNA. Deoxyribonucleotides include deoxyadenosine, deoxycytidine, deoxyguanosine and deoxythymidine. For RNA, the uracil base is uridine.

As used herein, the term “polynucleotide” refers to an oligomer or polymer containing at least two linked nucleotides or nucleotide derivatives, including a deoxyribonucleic acid (DNA), a ribonucleic acid (RNA), and a DNA or RNA derivative containing, for example, a nucleotide analog or a “backbone” bond other than a phosphodiester bond, for example, a phosphotriester bond, a phosphoramidate bond, a phophorothioate bond, a thioester bond, or a peptide bond (peptide nucleic acid). The term “oligonucleotide” also is used herein essentially synonymously with “polynucleotide,” although those in the art recognize that oligonucleotides, for example, PCR primers, generally are less than about fifty to one hundred nucleotides in length.

Nucleotide analogs contained in a polynucleotide can be, for example, mass modified nucleotides, which allows for mass differentiation of polynucleotides; nucleotides containing a detectable label such as a fluorescent, radioactive, luminescent or chemiluminescent label, which allows for detection of a polynucleotide; or nucleotides containing a reactive group such as biotin or a thiol group, which facilitates immobilization of a polynucleotide to a solid support. A polynucleotide also can contain one or more backbone bonds that are selectively cleavable, for example, chemically, enzymatically or photolytically. For example, a polynucleotide can include one or more deoxyribonucleotides, followed by one or more ribonucleotides, which can be followed by one or more deoxyribonucleotides, such a sequence being cleavable at the ribonucleotide sequence by base hydrolysis. A polynucleotide also can contain one or more bonds that are relatively resistant to cleavage, for example, a chimeric oligonucleotide primer, which can include nucleotides linked by peptide nucleic acid bonds and at least one nucleotide at the 3′ end, which is linked by a phosphodiester bond or other suitable bond, and is capable of being extended by a polymerase. Peptide nucleic acid sequences can be prepared using well known methods (see, for example, Weiler et al. Nucleic acids Res. 25: 2792-2799 (1997)).

As used herein, to hybridize under conditions of a specified stringency is used to describe the stability of hybrids formed between two single-stranded DNA fragments and refers to the conditions of ionic strength and temperature at which such hybrids are washed, following annealing under conditions of stringency less than or equal to that of the washing step. Typically high, medium and low stringency encompass the following conditions or equivalent conditions thereto:
high stringency: 0.1× SSPE or SSC, 0.1% SDS, 65° C.;
medium stringency: 0.2× SSPE or SSC, 0.1% SDS, 50° C.;
low stringency: 1.0× SSPE or SSC, 0.1% SDS, 50° C.

Equivalent conditions refer to conditions that select for substantially the same percentage of mismatch in the resulting hybrids. Additions of ingredients, such as formamide, Ficoll, and Denhardt's solution affect parameters such as the temperature under which the hybridization should be conducted and the rate of the reaction. Thus, hybridization in 5×SSC, in 20% formamide at 42° C. is substantially the same as the conditions recited above hybridization under conditions of low stringency. The recipes for SSPE, SSC and Denhardt's and the preparation of deionized formamide are described, for example, in Sambrook et al. (1989) Molecular Cloning, A Laboratory Manual, Cold Spring Harbor Laboratory Press, Chapter 8; see, Sambrook et al., vol. 3, p. B.13, see, also, numerous catalogs that describe commonly used laboratory solutions). It is understood that equivalent stringencies can be achieved using alternative buffers, salts and temperatures.

The term “substantially” identical or homologous or similar varies with the context as understood by those skilled in the relevant art and generally means at least 70%, preferably means at least 80%, more preferably at least 90%, and most preferably at least 95% identity.

The term “fragment,” “segment,” or “DNA segment” refers to a portion of a larger DNA polynucleotide or DNA. A polynucleotide, for example, can be broken up, or fragmented into, a plurality of segments. Various methods of fragmenting nucleic acids are well known in the art. These methods may be, for example, either chemical or physical in nature. Chemical fragmentation may include partial degradation with a DNAse; partial depurination with acid; the use of restriction enzymes; intron-encoded endonucleases; DNA-based cleavage methods, such as triplex and hybrid formation methods, that rely on the specific hybridization of a nucleic acid segment to localize a cleaveage agent to a specific location in the nucleic acid molecule; or other enzymes or compounds which cleave DNA at known or unknown locations. Physical fragmentation methods may involve subjecting the DNA to a high shear rate. High shear rates may be produced, for example, by moving DNA through a chamber or channel with pits or spikes, or forcing the DNA sample through a restricted size flow passage, e.g., an aperture having a cross sectional dimension in the micron or submicron scale. Other physical methods include sonication and nebulization. Combinations of physical and chemical fragmentation methods may likewise be employed such as fragmentation by heat and ion-mediated hydrolysis. See for example, Sambrook et al., “Molecular Cloning: A Laboratory Manual,” 3rd Ed. Cold Spring Harbor Laboratory Press, Cold Spring Harbor, N.Y. (2001) (“Sambrook et al.”) which is incorporated herein by reference in its entirety for all purposes. These methods can be optimized to digest a nucleic acid into fragments of a selected size range. Useful size ranges may be from 100, 200, 400, 700 or 1000 to 500, 800, 1500, 2000, 4000 or 10,000 base pairs. However, larger size ranges such as 4000, 10,000 or 20,000 to 10,000, 20,000 or 500,000 base pairs may also be useful.

Methods of ligation will be known to those of skill in the art and are described, for example in Sambrook et al. and the New England BioLabs catalog, both of which are incorporated herein in their entireties by reference for all purposes. Methods include using T4 DNA ligase, which catalyzes the formation of a phosphodiester bond between juxtaposed 5 phosphate and 3′ hydroxyl termini in duplex DNA or RNA with blunt or and sticky ends; Taq DNA ligase, which catalyzes the formation of a phosphodiester bond between juxtaposed 5′ phosphate and 3′ hydroxyl termini of two adjacent oligonucleotides that are hybridized to a complementary target DNA; E. coli DNA ligase, which catalyzes the formation of a phosphodiester bond between juxtaposed 5′-phosphate and 3′-hydroxyl termini in duplex DNA containing cohesive ends; and T4 RNA ligase which catalyzes ligation of a 5′ phosphoryl-terminated nucleic acid donor to a 3′ hydroxyl-terminated nucleic acid acceptor through the formation of a 3′→5′ phosphodiester bond, substrates include single-stranded RNA and DNA as well as dinucleoside pyrophosphates; or any other methods described in the art.

“Genome” designates or denotes the complete, single-copy set of genetic instructions for an organism as coded into the DNA of the organism. A genome may be multi-chromosomal such that the DNA is distributed among a plurality of individual chromosomes. For example, in human there are 22 pairs of chromosomes plus a gender associated XX or XY pair.

“Polymorphism” refers to the occurrence of two or more genetically determined alternative sequences or alleles in a population. A polymorphic marker or site is the locus at which divergence occurs. Preferred markers have at least two alleles, each occurring at a frequency of preferably greater than 1%, and more preferably greater than 10% or 20% of a selected population. A polymorphism may comprise one or more base changes, an insertion, a repeat, or a deletion. A polymorphic locus may be as small as one base pair. Polymorphic markers include single nucleotide polymorphisms (SNP's), restriction fragment length polymorphisms (RFLP's), variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. A polymorphism between two nucleic acids can occur naturally, or be caused by exposure to or contact with chemicals, enzymes, or other agents, or exposure to agents that cause damage to nucleic acids, for example, ultraviolet radiation, mutagens or carcinogens.

Single nucleotide polymorphisms (SNPs) are positions at which two alternative bases occur in the human population, and are the most common type of human genetic variation. The site is usually preceded by and followed by highly conserved sequences of the allele (e.g., sequences that vary in less than 1/100 or 1/1000 members of the populations). It is estimated that there are as many as 3×106 SNPs in the human genome. Variations that occur at a rate of at least 10% are referred to as common SNPs.

A single nucleotide polymorphism usually arises due to substitution of one nucleotide for another at the polymorphic site. A transition is the replacement of one purine by another purine or one pyrimidine by another pyrimidine. A transversion is the replacement of a purine by a pyrimidine or vice versa. Single nucleotide polymorphisms can also arise from a deletion of a nucleotide or an insertion of a nucleotide relative to a reference allele.

The term genotyping refers to the determination of the genetic information an individual carries at one or more positions in the genome. For example, genotyping may comprise the determination of which allele or alleles an individual carries for a single polymorphism or the determination of which allele or alleles an individual carries for a plurality of polymorphisms.

As used herein, “profiling” refers to detection and/or identification of a plurality of components, generally 3 or more, such as 4, 5, 6, 7, 8, 10, 50, 100, 500, 1000, 10⁴, 10⁵, 10⁶, 10⁷, or more, in a sample. A profile can include the identified loci to which components of a sample detectably bind or are otherwise located. The profile can be detected, e.g., in a multi-well plate, or as a pattern on a solid surface, in which case the profile can be presented as a visual image. The profile can be in the form of a list or database or other such compendium.

As used herein, an image refers to a collection of data points representative of a profile. An image can be a visual, graphical, tabular, matrix or other depiction of such data. It can be stored in a database.

As used herein, a database refers to a collection of data items.

As used herein, in an addressable collection of components of interest, such as a library of transcription regulatory elements (with pre-determined sequences), expression vectors encoding transcription regulatory elements, and cells containing expression vectors encoding transcription regulatory elements, each member of the collection is labeled and/or is positionally located to permit identification of each of member of the components. The addressable collection is typically an array or other encoded (such as bio-barcoded with unique nucleic acid tags) collection in which each locus contains a single, unique component and is identifiable. The collection can be in the liquid phase if other discrete identifiers, such as chemical, electronic, colored, fluorescent or other tags are included.

As used herein, an address refers to a unique identifier whereby an addressed entity can be identified. An addressed moiety is one that can be identified by virtue of its address. Addressing can be effected by position on a surface or by other identifier, such as a tag encoded with a bar code or other symbology, a chemical tag, an electronic, such RF tag, a color-coded tag or other such identifier.

As used herein, a nucleotide barcode refers to a specific type of address, more specifically, predesigned, predetermined and unique nucleotide sequence tag which can be used to uniquely identify each member in a collection of transcription regulatory elements, expression vectors encoding transcription regulatory elements, and cells containing expression vectors encoding transcription regulatory elements. Such a nucleic acid barcode may be 3-200, 5-200, 8-100, or 10-50 nucleotides in length, and discrete and tailorable hybridization and melting properties. Barcodes are heterologous to the molecules they tag.

A “panel” is a collection of a plurality of physically separated items belonging to a defined category. Thus, this invention relates to panels of expression vectors or cells. The items can be physically separated, for example, in different test tubes, in different wells of a microtiter plate or at different locations on an array to which they are attached.

An “array” comprises a support, preferably solid, comprising a plurality of different, known locations at which an item can be placed. Arrays include, for example, microtiter plates with addressable wells and chips comprising bound molecules at addressable locations. Members of the array may be identified by virtue of an identifiable or detectable label, such as by color, fluorescence, electronic signal (i.e., RF, microwave or other frequency that does not substantially alter the interaction of the molecules of interest), bar code (such as bio-barcode with unique nucleic acid tags) or other symbology, chemical or other such label. For example, the members of the array may be positioned in a container such as a well of a multi-well plate (such as a microtiter plate with 96, 384, or 1536 loci) or a vial, or immobilized to discrete identifiable loci on the surface of a solid phase or directly or indirectly linked to or otherwise associated with the identifiable label, such as affixed to a microsphere or other particulate support (herein referred to as beads) and suspended in solution or spread out on a surface. A microarray, which is used by those of skill in the art, generally is a positionally addressable array, such as an array on a solid support, in which the loci of the array are at high density. Examples of hybridization arrays, also described as “microarrays” or colloquially “chips” have been generally described in the art, for example, U.S. Pat. Nos. 5,143,854, 5,445,934, 5,744,305, 5,677,195, 5,800,992, 6,040,193, 5,424,186 and Fodor et al., Science, 251:767-777 (1991).

Arrays may generally be produced using a variety of techniques, such as mechanical synthesis methods or light directed synthesis methods that incorporate a combination of photolithographic methods and solid phase synthesis methods. Techniques for the synthesis of these arrays using mechanical synthesis methods are described in, e.g., U.S. Pat. Nos. 5,384,261, and 6,040,193, which are incorporated herein by reference in their entirety for all purposes. Although a planar array surface is preferred, the array may be fabricated on a surface of virtually any shape or even a multiplicity of surfaces. Arrays may be nucleic acids on beads, gels, polymeric surfaces, fibers such as fiber optics, glass or any other appropriate substrate. (See U.S. Pat. Nos. 5,770,358, 5,789,162, 5,708,153, 6,040,193 and 5,800,992.)

As used herein, a support (also referred to as a matrix support, a matrix, an insoluble support or solid support) refers to any solid or semisolid or insoluble support to which an item, e.g., a molecule of interest, typically a biological molecule, organic molecule or biospecific ligand can be linked or contacted. Such materials include any materials that are used as affinity matrices or supports for chemical and biological molecule syntheses and analyses, such as, but are not limited to: polystyrene, polycarbonate, polypropylene, nylon, glass, dextran, chitin, sand, pumice, agarose, polysaccharides, dendrimers, buckyballs, polyacrylamide, silicon, rubber, and other materials used as supports for solid phase syntheses, affinity separations and purifications, hybridization reactions, immunoassays and other such applications. The matrix herein can be particulate or can be a be in the form of a continuous surface, such as a microtiter dish or well, a glass slide, a silicon chip, a nitrocellulose sheet, nylon mesh, or other such materials.

As used herein, matrix or support particles refer to matrix materials that are in the form of discrete particles. The particles have any shape and dimensions, but typically have at least one dimension that is 100 μm or less, 50 μm or less and typically have a size that is 100 mm³ or less, 50 mm³ or less, 10 mm³ or less, and 1 mm³ or less, 100 μm³ or less and may be order of cubic microns. Such particles are collectively called “beads.” They are often, but not necessarily, spherical. Such reference, however, does not constrain the geometry of the matrix, which can be any shape, including random shapes, needles, fibers, and elongated. Roughly spherical “beads”, particularly microspheres that can be used in the liquid phase, are also contemplated. The “beads” can include additional components, such as magnetic or paramagnetic particles (see, e.g., Dyna beads (Dynal, Oslo, Norway)) for separation using magnets, as long as the additional components do not interfere with the methods and analyses herein.

As used herein, a “library” is a collection of items. In certain embodiments the library is “addressable,” i.e., members of the library comprise an identifying tag or are physically located at a different, discrete, known locations, such as contained within different wells of a multi-well plate or different containers.

As used herein, “array library” refers to the collections of addressable elements or components created by physical separation of the mixed library into a number of discrete collections.

As used herein, biological sample refers to any sample obtained from a living or viral source and includes any cell type or tissue of a subject from which nucleic acid or protein or other macromolecule can be obtained. Biological samples include, but are not limited to, cell lystates, cells, body fluids, such as blood, plasma, serum, cerebrospinal fluid, synovial fluid, urine and sweat, tissue and organ samples from animals and plants, such as humans, non-human mammals such as monkeys, dogs, pigs, horses, cats, rabbits, rats, and mice, and other vertebrates such as birds and fish. Also included are soil and water samples and other environmental samples, viruses, bacteria, fungi algae, protozoa and components thereof. The methods herein can be practiced using biological samples and in some embodiments, such as for profiling, can also be used for testing any sample.

As used herein, “a reporter gene construct” is a nucleic acid molecule that includes a nucleic acid encoding a reporter operatively linked to a transcriptional control sequence. Transcription of the reporter gene is controlled by these sequences. The activity of at least one or more of these control sequences is directly or indirectly regulated by transcription factors and other proteins or biomolecules. The transcriptional control sequences include the promoter and other regulatory regions, such as enhancer sequences, that modulate the activity of the promoter, or control sequences that modulate the activity or efficiency of the RNA polymerase that recognizes the promoter, or control sequences are recognized by effector molecules. Such sequences are herein collectively referred to as transcriptional regulatory elements or sequences.

As used herein, “reporter” or “reporter moiety” refers to any moiety that allows for the detection of a molecule of interest, such as a protein expressed by a cell, or a biological particle. Typical reporter moieties include, include, for example, light emitting proteins (e.g., luciferase, fluorescent proteins, such as red, blue and green fluorescent proteins (see, e.g., U.S. Pat. No. 6,232,107, which provides GFPs from Renilla species and other species)), enzymatic reporters, the lacZ gene from E. coli, alkaline phosphatase, secreted embryonic alkaline phosphatase (SEAP), chloramphenicol acetyl transferase (CAT), hormones and cytokines and other such well-known genes. For expression in cells, nucleic acid encoding the reporter moiety can be expressed as a fusion protein with a protein of interest or under to the control of a promoter of interest. The expression of these reporter genes can also be monitored by measuring levels of mRNA transcribed from these genes.

“Operatively linked” or “operably linked” refers to a functional arrangement of elements wherein the activity of one element (e.g., a promoter or a UTR) results in an action on the other element (e.g., a nucleotide sequence). Thus, a given promoter that is operably linked to a coding sequence (e.g., a reporter gene) is capable of effecting the transcription of the coding sequence when the proper enzymes are present. A UTR that is operably linked with a coding sequence is capable of effecting translation of the coding sequence. The promoter or other control elements need not be contiguous with the coding sequence, so long as they function to direct the expression thereof. For example, intervening untranslated yet transcribed sequences can be present between the promoter sequence and the coding sequence and the promoter sequence can still be considered “operably linked” to the coding sequence.

As used herein, regulatory molecule refers to a polymer of deoxyribonucleic acid (DNA) or ribonucleic acid (RNA), or an oligonucleotide mimetic, or a polypeptide or other molecule that is capable of enhancing or inhibiting expression of a gene.

As used herein, the terms “transcription regulatory region” or “transcription regulatory sequence” mean a nucleotide sequence that influences expression, positively or negatively, of an operatively linked gene. Regulatory regions include sequences of nucleotides that confer inducible (i.e., require a substance or stimulus for increased transcription) expression of a gene. When an inducer is present, or at increased concentration, gene expression increases. Regulatory regions also include sequences that confer repression of gene expression (i.e., a substance or stimulus decreases transcription). When a repressor is present or at increased concentration, gene expression decreases. Regulatory regions are known to influence, modulate or control many in vivo biological activities including cell proliferation, cell growth and death, cell differentiation and immune-modulation. Regulatory regions typically bind one or more trans-acting proteins which results in either increased or decreased transcription of the gene. In certain embodiments, the regulatory regions are cis-acting.

Particular examples of gene regulatory regions are promoters and enhancers. Promoters are sequences located around the transcription start site, typically positioned 5′ of the transcription start site. Enhancers are known to influence gene expression when positioned 5′ or 3′ of the gene, or when positioned in or a part of an exon or an intron. Enhancers also can function at a significant distance from the gene, for example, at a distance from about 3 Kb, 5 Kb, 7 Kb, 10 Kb, 15 Kb or more.

As used herein, a promoter region refers to the portion of DNA of a gene that controls transcription of the DNA to which it is operatively linked. The promoter region includes specific sequences of DNA that are sufficient for RNA polymerase recognition, binding and transcription initiation. This portion of the promoter region is referred to as the core promoter. In addition, the promoter region includes sequences that modulate this recognition, binding and transcription initiation activity of the RNA polymerase. These sequences can be cis acting or can be responsive to trans acting factors. Promoters, depending upon the nature of the regulation, can be constitutive or regulated.

Regulatory regions also include, in addition to promoter regions, sequences that facilitate translation, transcript stability, splicing signals for introns, maintenance of the correct reading frame of the gene to permit in-frame translation of mRNA, leader sequences and fusion partner sequences, internal ribosome binding sites (IRES) elements for the creation of multigene, or polycistronic, messages, polyadenylation signals to provide proper polyadenylation of the transcript of a gene of interest and stop codons and can be optionally included in an expression vector.

As used herein, a composition refers to any mixture. It can be a solution, a suspension, liquid, powder, a paste, aqueous, non-aqueous or any combination thereof.

As used herein, a combination refers to any association between among two or more items. The combination can be two or more separate items, such as two compositions or two collections, can be a mixture thereof, such as a single mixture of the two or more items, or any variation thereof.

As used herein, a kit refers to a packaged combination, optionally including instructions and/or reagents for their use.

As used herein, two nucleic acid segments are “heterologous” with respect to each other if their sequences are not found in the same genome or are not normally linked to one another within 10000 nucleotides in the same genome.

As used herein, a nucleic acid molecule is “isolated” if it is removed from its natural milieu in a genome and/or cell.

A nucleic acid molecule is “pure” or “purified” if it is the predominant biomolecular species in a mixture.

### EXAMPLES

### Example 1

### Description of Algorithm Used to Predict Human 3′ Untranslated Regions

The algorithm first downloads every RefSeq human cDNA sequence at NCBI. Next, the open reading frame (ORF) is identified for each cDNA sequence by finding the longest string of codons that begins with a methionine (AUG) and ends with one of the three stop codons (UAG, UGA, UAA). Each Refseq cDNA sequence with annotated ORF is then aligned to the human genome sequence to identify the exon structure and genomic location of each gene.

The algorithm then analyzes the exon structure at the 3′ end of the gene. If the last intron on the refseq alignment is less than 100 bp, it merges the last 2 exons and designates that as the last exon. The algorithm then looks at where the ORF ends and determines whether the UTR is spliced or not based on whether it is interrupted by an intron. If the UTR is spliced, the algorithm determines the length of the intron and also determines how much of the UTR is located in the second to last exon and also whether the coding sequence ends before the second to last exon.

The algorithm then merges overlapping UTR sequences to eliminate redundancy. First the algorithm sorts based on the coordinate of the UTR beg, then it merges UTR coordinates if any of the following criteria are true:
1. the difference between the last beg and the current beg coordinate <500 bp
2. if the difference between the last end and the current end coordinate <500 bp

For each group of merged UTR coordinates, the lowest coordinate and highest coordinate are recorded, and the Refseq IDs for every UTR are recorded.

### Example 2

### Pilot Experiment Demonstrating the Function of the Human Transferring Receptor UTR

The scientific literature reveals a handful of genes for which studies of the function of both transcriptional and post-transcriptional regulatory elements have been carried out, and in all cases such studies have yielded valuable insight into that gene's regulation. One of the best studied cases is that of the human Transferrin Receptor gene (hTR). hTR protein levels are known to increase more than 10-fold upon addition of an iron-chelator (DFO) to cells in culture. A panel of literature has shown that both the promoter and the 3′ UTR play necessary roles in mediating the change total protein output from the locus needed for an adequate response to iron depletion, and each is sufficient to supply moderate increases in gene expression response on its own. Specifically, Casey et al. (1988) found that the TFRC promoter's activity increases ˜2.8 fold upon treatment with DFO (an iron chelator). And to explore post-transcriptional regulation, Mullner et al. (1988) constructed a TFRC “minigene” on a plasmid and showed that when the entire 3′ UTR is deleted, the expression response to DFO is decreased by ˜3 fold.

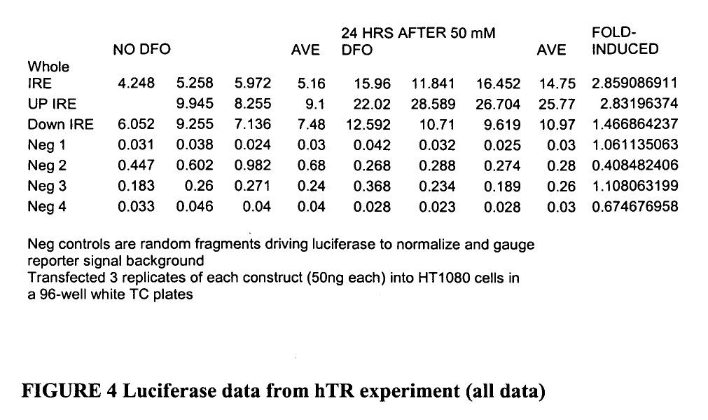

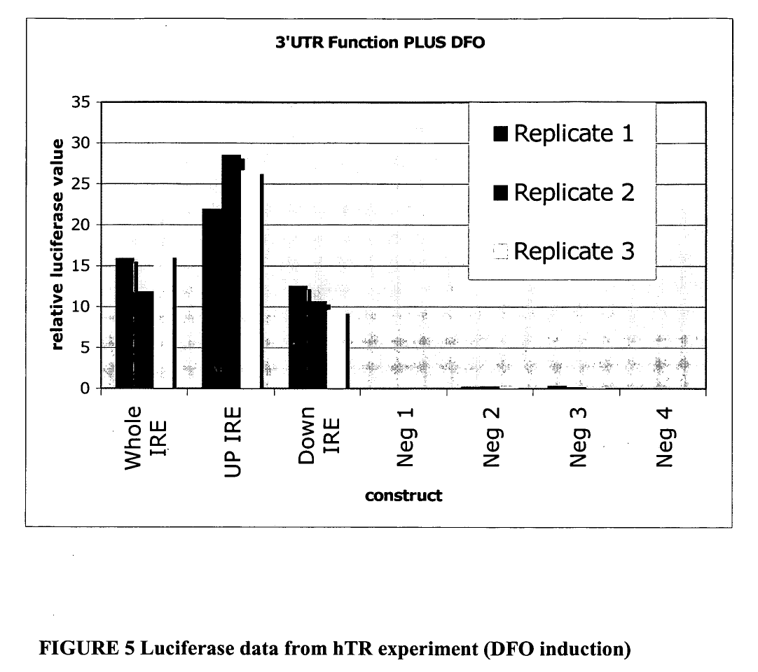

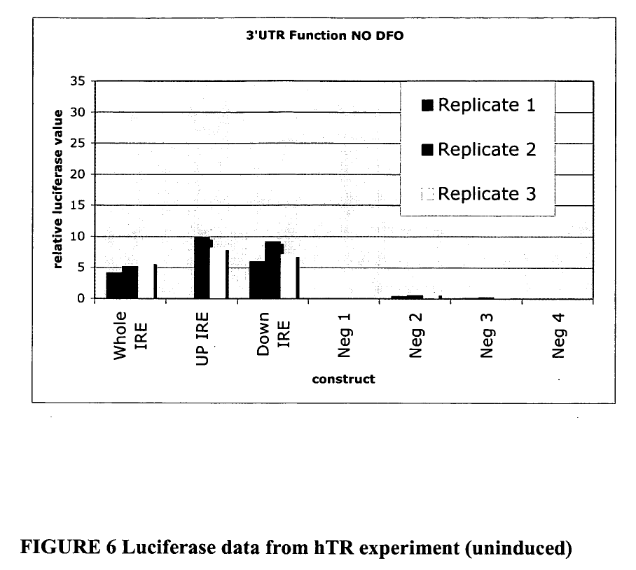

To test the SwitchGear 3′UTR reporter vector for measuring the effect of different 3'UTRs and mutations contained in 3′ UTRs on protein expression, we cloned different fragments of the hTR 3′UTR downstream of a luciferase reporter cassette on a plasmid driven by a moderately strong promoter. We transfected vectors containing different regions of the hTR 3′UTR into tissue culture cells and measured luciferase output from each at normal intracellular iron concentrations and then in the presence of DFO (a small molecule that reduces available iron). Previous published research has utilized similar approaches, though with different reporter cassettes and vectors. The results summarized in FIGS. 4 through 6 show that the full IRE-containing UTR increases the amount of transcript ˜3 fold upon treatment with DFO, which is consistent with what we expected based on previous published reports.

The three UTR sequences analyzed in the hTR experiment are segments of SEQ ID NO. 12265. They are labeled: “Whole IRE”, which contains both of the IREs in the hTR UTR; “UP IRE”, which contains the most 5′ IRE in the hTR UTR; and “Down IRE”, which contains the most 3′ IRE in the hTR UTR.

### REFERENCES

Casey, J. L., B. Di Jeso, K. Rao, R. D. Klausner, and J. B. Harford. 1988. Two genetic loci participate in the regulation by iron of the gene for the human transferrin receptor. Proc Natl Acad Sci USA. 85:1787-91.

Collins, F. S., J. E. Metherall, M. Yamakawa, J. Pan, S. M. Weissman, and F. G. Forget. 1985. A point mutation in the A gamma-globin gene promoter in Greek hereditary persistence of fetal haemoglobin. Nature 313: 325-6.

Conne, B., A. Stutz, and J. Vassalli. 2000. The 3′ untranslated region of messenger RNA: A molecular hotspot for pathology? Nature Med. 6: 636-641.

Cooper, S. J., N. D. Trinklein, E. D. Anton, L. Nguyen, and R. M. Myers. 2006. Comprehensive analysis of transcriptional promoter structure and function in 1% of the human genome. Genome Res. 16:1-10.

Kulozik, A. E., A. Bellan-Koch, S. Bail, E. Kohne, and E. Kleihauer. 1991. Thalassemia intermedia: moderate reduction of beta globin gene transcriptional activity by a novel mutation of the proximal CACCC promoter element. Blood 77: 2054-8.

Mazumder, B., V. Seshadri, and P. L. Fox. 2003. Translational control by the 3′-UTR: the ends specify the means. Trends in Biochem Sci. 28: 91-98.

Mullner, E. W., and L. C. Kuhn. 1988. A stem-loop in the 3′ untranslated region mediates iron-dependent regulation of transferrin receptor mRNA stability in the cytoplasm. Cell 53:815-25.

Myers, R. M, K. Tilly; and T. Maniatis. 1986. Fine structure genetic analysis of a beta-globin promoter. Science 232: 613-8.

Pesole, G., L. Sabino, G. Grillo, F. Licciulli, F. Mignone, C. Gissi, and C. Saccone. 2002. UTRdb and UTRsite: specialized databases of sequences and functional elements of 5′ and 3′ untranslated regions of eukaryotic mRNAs. Update 2002. Nucleic Acids Res. 30: 335-40.

Rimokh, R., B. Francoise, C. Bastard, B. Klein, M. French, E. Archimbaud, J. P. Rouault, B. Santa Lucia, L. Duret, M. Vuillaume, B. Coiffier, P. Bryon, and J. P. Magaud. 1994. Rearrangement of CCND1 (BCL1/PRAD1) 3′ untranslated region in mantle-cell lymphomas and t(11q13)-associated leukemias. Blood 12: 3689-96.

Theodorakis, N. G., and R. I. Morimoto. 1987. Posttranscriptional regulation of hsp70 expression in human cells: effects of heat shock, inhibition of protein synthesis, and adenovirus infection on translation and mRNA stability. Mol Cell Biol. 7: 4357-68.

Trinklein, N. D., S. J. Aldred, A. J. Saldanha, and R. M. Myers. 2003. Identification and functional analysis of human transcriptional promoters. Genome Res 13: 308-312.

Weiss, I. M., and S. A. Liebhaber. 1995. Erythroid cell-specific mRNA stability elements in the alpha2-globin 3′ nontranslated region. Mol Cell Biol. 15: 2457-65.

Xie, X., J. Lu, E. J. Kulbokas, T. R. Golub, V. Mootha, K. Lindblad-Toh, E. S. Lander, and M. Kellis. 2005. Systematic discovery of regulatory motifs in human promoters and 3′ UTRs by comparison of several mammals. Nature 434: 338-45.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A library of a different expression constructs, each of a plurality of members of the library comprising a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences.

2. The library of claim 1 wherein the UTR sequence is a 3′ UTR sequence and is positioned 3′ to the reporter sequence.

3. The library of claim 1 wherein the UTR sequence is a 5′ UTR sequence and is positioned 5′ to the reporter sequence.

4. The library of claim 1 wherein the transcribable sequence comprises a 3′ UTR sequence positioned 3′ to the reporter sequence and a 5′ UTR sequence positioned 5′ to the reporter sequence.

5. The library of claim 1 wherein the transcription regulatory sequence is common among the constructs and is heterologous to the UTR sequences.

6. The library of claim 1 wherein the UTR sequence comprises the entire transcribed UTR sequence of a naturally occuring transcript.

7. The library of claim 1 wherein a plurality comprising at least 20% of the UTR sequences of said expression constructs in said library are part of a common pathway that can include:
(a) UTR sequences that control the expression of genes involved in the same biological process;
(b) UTR sequences that are all bound by the same protein, complex of proteins, other nucleic acid binding proteins, other nucleir acid molecules such as microRNAs, or other small molecule;
(c) UTR sequences that control the expression of genes whose transcript levels or proteins levels change upon treatment or exposure to the same stimulus;
(d) UTR sequences that contain the same sequence motif or collection of sequence motifs wherein a sequence motif is string of 2 or more nucleotides; or
(e) UTR sequences that control the expression of genes whose sequences, transcripts or proteins are connected via metabolic transformations and/or physical protein-protein, protein-DNA and protein-compound interactions

8. The library of claim 1 wherein the UTR sequences are selected from the group consisting of SEQ ID NO: 1-17520.

9. The library of claim 1 wherein the plurality comprises at least ten, at least 50, at least 100, at least 200, or at least 1000 expression constructs.

10. The library of claim 1, wherein the expression construct is a plasmid or viral construct.

11. The library of claim 1, wherein each nucleic acid segment comprises at least 20%, at least 40%, at least 60%, or at least 80% of the nucleotides that make up a UTR sequence.

12. The library of claim 1, wherein the reporter sequence is common among the constructs.

13. The library of claim 1, wherein the reporter sequence encodes a light-emitting reporter molecule, a fluorescent reporter molecule or a colorimetric molecule.

14. The library of claim 1, wherein each reporter sequence comprises a pre-determined, unique nucleotide barcode and/or a reporter that reports a visible signal.

15. The library of claim 1, wherein the genome is a mammalian genome.

16. The library of claim 1, wherein the genome is a human genome.

17. The library of claim 1, wherein the genome is a mouse genome.

18. A library of isolated nucleic acid molecules, each member of the library comprising a different, pre-determined nucleic acid segment from a genome, wherein the segment comprises UTR sequences, wherein a plurality comprising at least 20% of the UTR sequences in said library are part of a common pathway.

19. The library of claim 18 comprising at least 10 different pre-determined nucleic acid segment from a genome, wherein about 50% of the UTR sequences of said library are part of said common pathway.

20. A library of cells, wherein each of a plurality of cells in the library of cells comprises a different expression construct, each construct having a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences.

21. The library of claim 20 wherein the cells are human cells.

22. The library of claim 20 wherein the cells are non-human cells.

23. A device comprising receptacles, each of a plurality of the receptacles containing a different expression construct, each expression construct having a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences, wherein each member has a known location among the receptacles.

24. The device of claim 23, wherein the library has a diversity of at least 10 different nucleic acid segments.

25. The device of claim 23, wherein the constructs are in the form of a dried nucleic acid or are in solution.

26. The device of claim 23, wherein the constructs are in a stabilized transfection matrix.

27. The device of claim 23, wherein a microtiter plate such as a 96-well plate, a 384-well plate or a 1536 well plate.

28. The device of claim 23, wherein at least at least 10 different expression constructs wherein about 50% of the UTR sequences of said expression constructs in said library are part of said common pathway.

29. A device comprising a solid substrate comprising a surface and nucleic acid molecules immobilized to the surface, each at a different known location, wherein each molecule comprises a nucleotide sequence of at least 10 nucleotides from a genomic segment comprising UTR sequences.

30. The device of claim 29 wherein said device comprises UTR sequences from at least 10 different genomic segments.

31. The device of claim 29 comprising at least 10 different UTR sequences from genomic segments wherein about 50% of the UTR sequences in said device are part of a common pathway.

32. A method comprising:
(a) providing a device comprising receptacles, each of a plurality of the receptacles containing a different member of a library of cells, wherein each of a plurality of the cells in the library comprises a different member of the library of expression constructs, each of a plurality of the expression constructs characterized by having a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences; wherein each member of the library of cells has a known location among the receptacles;
(b) culturing the cells; and
(c) measuring the level of expression of the reporter sequence in each receptacle.

33. The method of claim 32 wherein the library has a diversity of at least 10 different nucleic acid segments.

34. The method of claim 32 wherein the step of providing the device comprises:
(a) providing a device comprising at least one plate comprising a plurality of receptacles, each receptacle containing a different member of the library of expression constructs, wherein each member of the library of expression constructs has a known location among the receptacles;
(b) delivering cells to each of the receptacles; and
(c) transfecting the cells with the expression constructs.

35. The method of claim 32 further comprising:
(a) perturbing the cells in each receptacle;
(b) measuring the level of expression of the reporter sequence in each receptacle; and
(c) determining whether the level of expression in any receptacle changed after perturbing the cells.

36. The method of claim 32 wherein perturbing comprises contacting the cells in each receptacle with a test compound, exposing the cells to different environmental conditions, or genetically modifying the cells either permanently or transiently such as by inducing mutation, overexpressing a transcript for example by transfecting with a cDNA or decreasing expression of a transcript by siRNA.

37. The method of claim 32 wherein perturbing comprises contacting the cells in each receptacle with a test compound.

38. The method of claim 32 further comprising identifying a compound that alters UTR activity.

39. The method of claim 32 wherein said cells in said library of cells comprises cells associated with a condition.

40. The method of claim 32 wherein each cell in said library of cells comprises a DNA polymorphism such as SNP, STR, VTR and RFLP, or DNA mutation.

41. A method to determine the functional effect of a DNA polymorphism or DNA mutation in the post-transcriptional activity of a polynucleotide comprising:
(a) providing a first library of cells wherein said first library comprises cells comprising said DNA polymorphism or DNA mutation;
(b) providing a second library of cells wherein said second library comprises cells not comprising said DNA polymorphism or DNA mutation;
(c) providing a device comprising a plurality of receptacles, each receptacle containing a different member of said first library of cells or said second library of cells, wherein each cell in said first and second library of cells comprises a different member of the library of expression constructs, each expression construct characterized by having a transcription regulatory sequence operably linked with a different transcribable sequence, wherein the transcription of the transcribable sequence is under transcriptional control of the transcriptional regulatory sequence, and wherein each transcribable sequence comprises a different nucleic acid segment from a genome, wherein the segment comprises untranslated region (UTR) sequence of at least 10 nucleotides operably linked with a reporter sequence that is heterologous to the UTR sequence such that expression of the reporter sequence is under post-transcriptional control of the UTR sequences; wherein a plurality comprising at least 20% of the UTR sequences in said device are part of a common pathway and wherein each member of the library of cells has a known location among the receptacles;
(d) culturing the cells;
(e) measuring the level of expression of the reporter sequence in each receptacle;
(f) comparing the level of expression of the reporter sequence to each UTR sequence between said first library of cells and said second library of cells thereby determining the effect of said DNA polymorphism or DNA mutation in the post-transcriptional regulation of a polynucleotide.

42. The method of claim 41 wherein said DNA polymorphism is selected for the group consisting of SNP, STR, VTR, RFLP, deletions, and insertions.

43. A business method comprising commercializing the compositions, devices of methods of any of claims 1, 18, 20, 23, 29, 32 and 41.
